(19) United States
(12) Patent Application Publication
(10) Pub. No.: US 2025/0065629 A1
(43) Pub. Date: Feb. 27, 2025

(54) MAINTENANCE DEVICE AND INKJET RECORDING APPARATUS

(71) Applicant: KYOCERA Document Solutions Inc., Osaka (JP)

(72) Inventors: Yiquan NIE, Osaka-shi (JP); Takashi SOMETE, Osaka-shi (JP)

(73) Assignee: KYOCERA Document Solutions Inc., Osaka (JP)

(21) Appl. No.: 18/811,341

(22) Filed: Aug. 21, 2024

(30) Foreign Application Priority Data
Aug. 22, 2023 (JP) 2023-134340

(51) Int. Cl. B41J 2/165

(52) U.S. Cl. CPC B41J 2/16508

(57) ABSTRACT

A maintenance device includes a cap, an air supply port, an air discharge port, and a suppression member. The cap covers a nozzle surface of an inkjet head. The air supply port and the air discharge port are provided in the cap. The suppression member is provided between the nozzle surface and the air supply port, and has a first gap from the air supply port and a second gap from the nozzle surface. The suppression member has a plurality of through-holes penetrating from a side of the air supply port to a side of the air discharge port at a position not facing the air supply port. The through-holes have the same diameter. The closer the through-holes are to the air discharge port, the higher a density of the through-holes is.

### INCORPORATION BY REFERENCE

This application is based on and claims the benefit of priority from Japanese patent application No. 2023-134340 filed on Aug. 22, 2023, which is incorporated by reference in its entirety.

### BACKGROUND

The present disclosure relates to a maintenance device performing maintenance of an inkjet head and an inkjet recording apparatus.

In an inkjet recording apparatus using water-based ink, water evaporates from the ink in a nozzle during a period when printing is not performed, and viscosity of the ink is increased, and there is a risk that ejection failure or clogging occurs. Accordingly, a technique for suppressing the evaporation of water from the ink in the nozzle has been studied. For example, there is a device for supplying humidified air into a cap covering an ejection surface (a nozzle surface) of a head.

However, in the above-described device, the humidified air is directly exposed to the nozzle surface, and in such a case, condensation may occur on the nozzle surface, and the ink may be pulled by the condensation and leave the nozzle. In addition, the humidified air is supplied from an air supply port provided in the cap, but the humidified air is difficult to reach the nozzle surface as it is separated from the air supply port, and the viscosity of the ink increases. Therefore, there is a problem that the ejection performance becomes uneven and the density of the image deviates from the image data.

### SUMMARY

A maintenance device according to the present disclosure includes a cap, an air supply port, an air discharge port, and a suppression member. The cap covers a nozzle surface of an inkjet head. The air supply port and the air discharge port are provided in the cap. The suppression member is provided between the nozzle surface and the air supply port, and has a first gap from the air supply port and a second gap from the nozzle surface. The suppression member has a plurality of through-holes penetrating from a side of the air supply port to a side of the air discharge port at a position not facing the air supply port. The through-holes have the same diameter. The closer the through-holes are to the air discharge port, the higher a density of the through-holes is.

An inkjet recording apparatus according to the present disclosure included the inkjet head; and the maintenance device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing an appearance of an image forming system according to a first embodiment of the present disclosure.

FIG. 2 is a front view schematically showing an internal structure of an inkjet recording apparatus according to the first embodiment of the present disclosure.

FIG. 3 is a front view schematically showing a head unit and a maintenance device according to the first embodiment of the present disclosure.

FIG. 4 is a plan view schematically showing the head unit and a wipe unit according to the first embodiment of the present disclosure.

FIG. 5 is a plan view schematically showing a cap unit according to the first embodiment of the present disclosure.

FIG. 6 is a cross-sectional view showing an inkjet head according to the first embodiment of the present disclosure.

FIG. 7A to FIG. 7G are front views explaining an operation of the maintenance device according to the first embodiment of the present disclosure.

FIG. 8 is a perspective view showing the cap unit according to the first embodiment of the present disclosure.

FIG. 9 is a plan view showing the cap unit according to the first embodiment of the present disclosure.

FIG. 10 is a cross-sectional view taken along the line I-I of FIG. 9.

FIG. 11 is a disassembled view showing the cap unit according to the first embodiment of the present disclosure.

FIG. 12 is a view explaining a flow of air and humidified air in the cap unit according to the first embodiment of the present disclosure.

FIG. 13 is a plan view showing positions of a humidification tank and a recovery tank according to the first embodiment of the present disclosure.

FIG. 14 is a cross-sectional view explaining a flow of humidified air in the cap according to the first embodiment of the present disclosure.

FIG. 15 is a cross-sectional view showing the cap unit provided with a suppression member according to the first embodiment of the present disclosure.

FIG. 16 is a plan view showing the cap provided with the suppression member according to the first embodiment of the present disclosure.

FIG. 17 is a cross-sectional view showing the cap unit provided with the suppression member according to a second embodiment of the present disclosure.

FIG. 18 is a plan view showing the cap provided with the suppression member according to the second embodiment of the present disclosure.

FIG. 19 is a plan view showing the cap provided with the suppression member according to a third embodiment of the present disclosure.

FIG. 20 is a plan view showing the cap provided with the suppression member according to a fourth embodiment of the present disclosure.

FIG. 21 is a plan view showing the cap provided with suppression member according to a fifth embodiment of the present disclosure.

FIG. 22 is a plan view showing the cap provided with the suppression member according to a sixth embodiment of the present disclosure.

FIG. 23 is a plan view showing the cap provided with the suppression member according to a seventh embodiment of the present disclosure.

FIG. 24 is a cross-sectional view taken along the line IV-IV of FIG. 22.

FIG. 25 is a cross-sectional view showing a first modified example of the sixth embodiment of the present disclosure.

FIG. 26 is a cross-sectional view showing a second modified example of the sixth embodiment of the present disclosure.

FIG. 27 is a cross-sectional view showing the cap unit provided with the suppression member according to an eighth embodiment of the present disclosure.

FIG. 28 is a plan view showing the cap provided with the suppression member according to the eighth embodiment.

### DETAILED DESCRIPTION

[First Embodiment] Hereinafter, with reference to the drawings, an inkjet recording apparatus 1 according to a first embodiment of the present disclosure will be described.

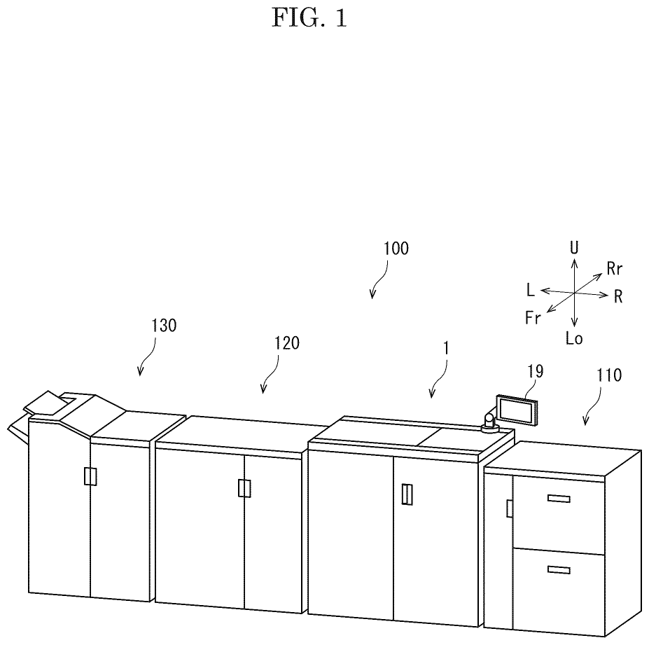

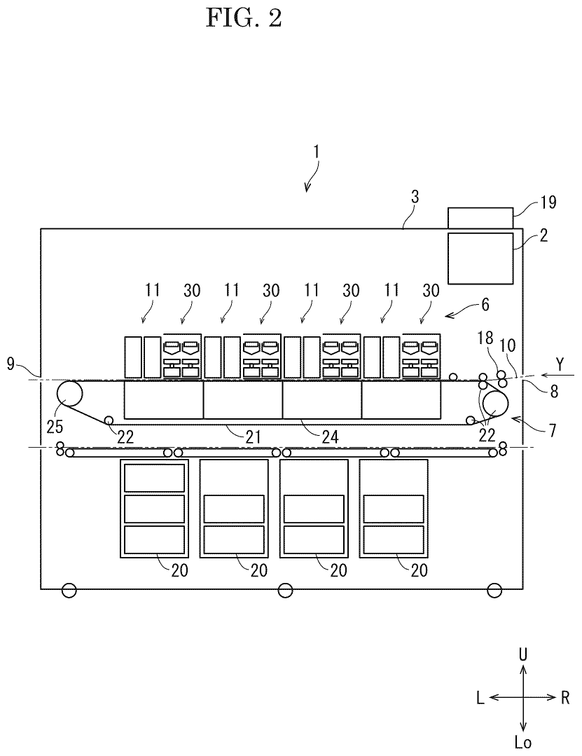

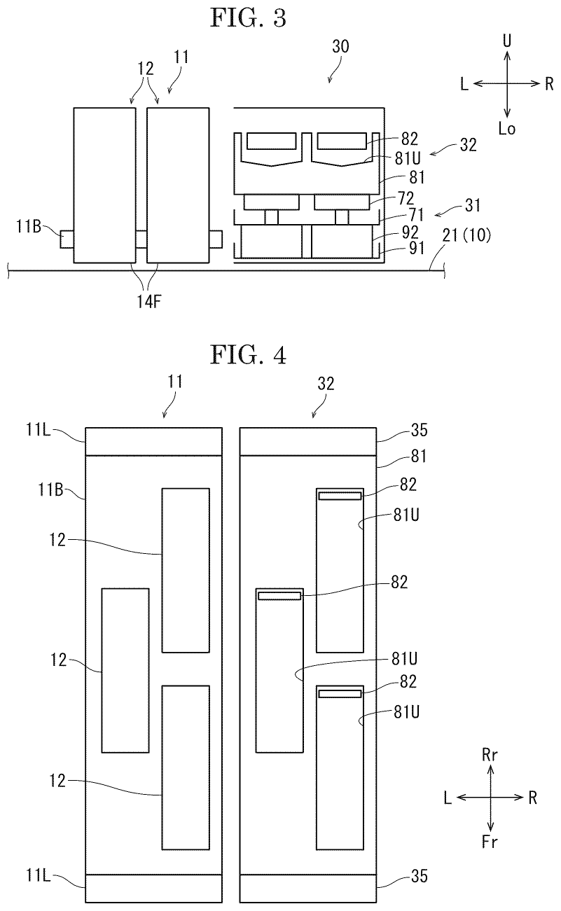

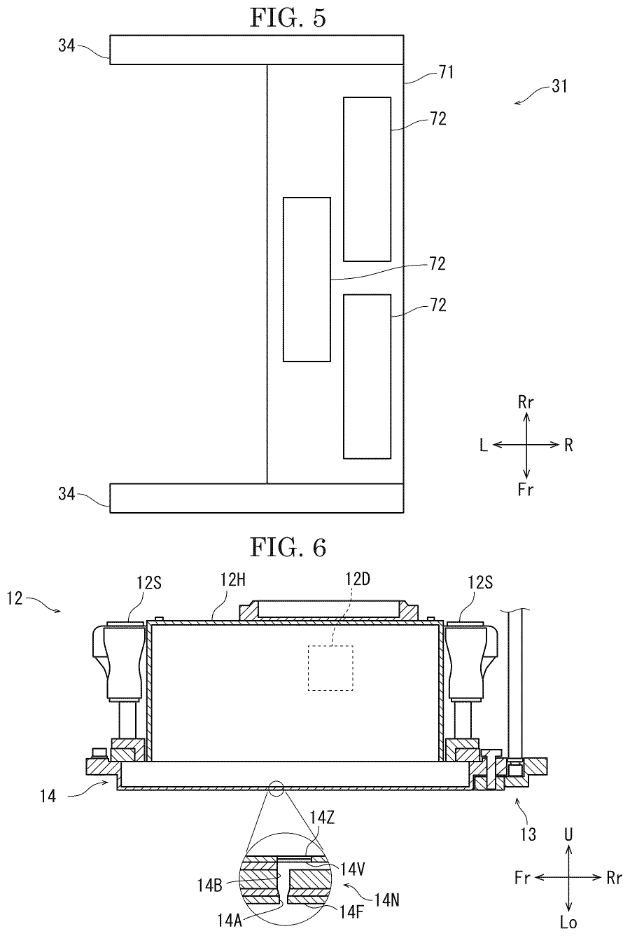

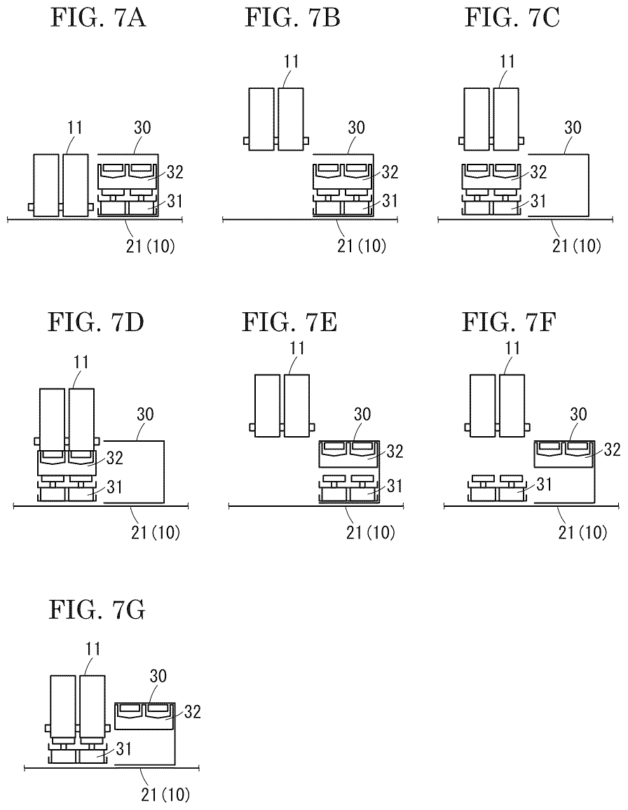

FIG. 1 is a perspective view showing the appearance of the image forming system 100. FIG. 2 is a front view schematically showing an internal structure of the inkjet recording apparatus 1. FIG. 3 is a front view schematically showing a head unit 11 and a maintenance device 30. FIG. 4 is a plan view schematically showing the head unit 11 and a wipe unit 32. FIG. 5 is a plan view schematically showing a cap unit 31. FIG. 6 is a cross-sectional view showing an inkjet head 12. FIG. 7A to FIG. 7G are front views explaining an operation of the maintenance device 30. Hereinafter, the front side of the paper plane on which FIG. 2 is drawn will be referred to as the front side of the inkjet recording apparatus 1, and the left-and-right direction will be described with reference to the direction in which the inkjet recording apparatus 1 is viewed from the front side. In each figure, U, Lo, L, R, Fr, and Rr indicate an upper, lower, left, right, front, and rear, respectively.

The image forming system 100 (see FIG. 1) includes a sheet feeding device 110, an inkjet recording apparatus 1, a drying device 120, and a post-processing device 130. The sheet feeding device 110 stores several thousand sheets, and feeds the sheets to the inkjet recording apparatus 1. The inkjet recording apparatus 1 forms an image on the sheet by an inkjet method. The drying device 120 heats the sheet conveyed from the inkjet recording apparatus 1 to dry the ink. The post-processing device 130 performs post-processing such as punching, stapling, folding, or the like on the sheet conveyed from the drying device 120.

The inkjet recording apparatus 1 (see FIG. 2) includes a box-shaped body housing 3. In the center portion inside the body housing 3, a conveying unit 7 which attracts the sheet and conveys it in the Y direction is provided. Above the conveying unit 7, an image forming unit 6 which forms an image by ejecting ink is provided. On the right side surface of the body housing 3, a sheet feeding port 8 through which the sheet is introduced from the sheet feeding device 110 is provided. On the left side surface of the body housing 3, a discharge port 9 through which the sheet on which the image is formed is discharged to the drying device 120 is provided. Inside the body housing 3, a conveyance path 10 is provided from the sheet feeding port 8 to the discharge port 9 between the conveying unit 7 and the image forming unit 6. A registration roller 18 is provided on the upstream side of the conveying unit 7 in the conveyance direction Y.

The conveying unit 7 includes an endless conveying belt 21 and a suction part 24. The conveying belt 21 has a large number of air holes (not shown), and is wound around a driving roller 25 and a driven roller 22. The upper surface of the suction part 24 has a large number of air holes (not shown), and is in contact with the inner surface of the conveying belt 21. The suction part 24 sucks air through the air holes of the conveying belt 21 and the air holes of the suction part 24, thereby attracting the sheet to the conveying belt 21. When the driving roller 25 is driven in the counterclockwise direction by a driving part (not shown) including a motor and a reduction gear, the conveying belt 21 travels in the counterclockwise direction, and the sheet attracted to the conveying belt 21 is conveyed in the Y direction.

The image forming unit 6 includes a plurality (in this embodiment, four) of head units 11. The head unit 11 (see FIG. 3 and FIG. 4) includes one or more (in this embodiment, three) inkjet heads 12. Ink containers 20 filled with black, cyan, magenta and yellow inks are connected to the head units 11.

The inkjet head 12 (see FIG. 6) includes a rectangular housing 12H whose longitudinal direction is along in the front-and-rear directions, a nozzle plate 14 provided at the bottom of the housing 12H, and a socket 12S to which a pipe for supplying the ink is connected. The nozzle plate 14 includes a large number of nozzles 14N arranged in the front-and-rear direction. The nozzle 14N includes a branch flow pass 14B branched from the downstream side of the socket 12S, and an ejection port 14A provided on a nozzle surface 14F which is a lower surface of the nozzle plate 14. A diaphragm 14V also serves as a part of the inner wall of the branch flow pass 14B. The diaphragm 14V is provided with a pressurizing element 14Z. As the pressurizing element 14Z, a piezoelectric element, an electrostatic actuator, a heater, or the like is used. A driving circuit 12D for driving the pressurizing element 14Z is connected to the pressurizing element 14Z.

The control part 2 (see FIG. 2) includes an arithmetic part and a storage part (not shown). The arithmetic part is, for example, a CPU (Central Processing Unit). The storage part includes a storage medium such as a ROM (Read Only Memory), a RAM (Random Access Memory), EEPROM an (Electrically Erasable Programmable Read Only Memory), and the like. The arithmetic part reads out the control program stored in the storage part and executes various processes. The control part 2 may be implemented by an integrated circuit that does not use software.

A display operation part 19 is provided on the upper portion of the body housing 3 (see FIG. 1 and FIG. 2). The display operation part 19 includes a display panel, a touch panel laminated on the display panel, and a keypad (not shown). The control part 2 displays a screen representing an operation menu, a status, or the like of the inkjet recording apparatus 1 on the display panel, and controls each part of the inkjet recording apparatus 1 in accordance with an operation detected by the touch panel and the keypad.

The basic image forming operation of the inkjet recording apparatus 1 is as follows. When an image forming job is inputted to the inkjet recording apparatus 1 from the display operation part 19 or an external computer, the sheet feeding device 110 feeds the sheet to the conveyance path 10 through the sheet feeding port 8, and the registration roller 18 whose rotation is stopped corrects the skew of the sheet. When the registration roller 18 sends the sheet to the conveying unit 7 at a predetermined timing, the conveying unit 7 attracts the sheet to the conveying belt 21 and conveys the sheet in the Y direction. The ink is ejected from the inkjet head 12 to form an image on the sheet. The sheet on which the image is formed is discharged to the drying device 120 through the discharge port 9.

[Maintenance Device] Next, a maintenance device 30 will be described. Since the four head units 11 have the same configuration and the four maintenance devices 30 have the same configuration, one head unit 11 and one maintenance device 30 provided on the right side of the head unit 11 will be described below.

The head unit 11 includes a head base 11B (see FIG. 3 and FIG. 4) by which the inkjet head 12 is supported. On the head base 11B, the three inkjet heads 12 are arranged in a staggered pattern.

The maintenance device 30 (see FIG. 3) is provided on the lateral side (in this embodiment, the right side) of the head unit 11. The maintenance device 30 includes a cap unit 31 and a wipe unit 32.

[Cap Unit] The cap unit 31 (see FIG. 3 and FIG. 5) incudes caps 72 having the same number (in this embodiment, three) as the inkjet heads 12 provided in the head unit 11. The three caps 72 are arranged in a staggered pattern in the same manner as the inkjet heads 12, and are supported by a frame 71. Two caps 72 are arranged along the front-and-rear direction on the right side portion of the frame 71, and one cap 72 is arranged on the left side portion of the frame 71. One cap 72 on the left side portion is disposed between the two caps 72 in the front-and-rear direction.

[Wipe Unit] The wipe unit 32 (see FIG. 3 and FIG. 4) includes a waste liquid tray 81 and a cleaning member 82. The waste liquid tray 81 has the same number of recesses 81U as the inkjet heads 12 provided in the head unit 11. The recesses 81U are arranged in a staggered pattern in the same manner as the inkjet heads 12. The cleaning member 82 is provided in each of the recesses 81U. The cleaning member 82 is, for example, a blade. The waste liquid tray 81 includes a driving part (not shown) for sliding the cleaning members 82 along the nozzle surfaces 14F. The waste liquid tray 81 is mounted on the caps 72. In other words, the wipe unit 32 is mounted on the cap unit 31. The head unit 11 is provided with a cleaning liquid supply device 13 (see FIG. 6) for supplying cleaning liquid to the nozzle surface 14F.

[Head Lifting Device] A head lifting device 11L (see FIG. 4) is provided on the front and rear sides of the head base 11B. The head lifting device 11L includes, for example, a ball screw, a belt driving device, and the like. The head lifting device 11L lifts and lowers the head unit 11 between an image forming position and a retracted position. The image forming position (see FIG. 7A) is a position where a distance between the conveyance path 10 (the upper surface of the conveying belt 21) along which the sheet is conveyed and the nozzle surface 14F has a predetermined distance suitable for the image forming. The image forming position is the lower limit position of the lifting range of the head unit 11 by the head lifting device 11L. The retracted position (see FIG. 7B) is a position where the head unit 11 does not interfere with the wipe unit 32 when the cap unit 31 and the wipe unit 32 are slid using a cap sliding device 34 described later. The retracted position is the upper limit position of the lifting range of the head unit 11.

[Cap Sliding Device] The cap sliding device 34 (see FIG. 5) is provided on the front and rear sides of the frame 71 of the cap unit 31. The cap sliding device 34 includes, for example, a ball screw, a belt driving device, and the like. The cap sliding device 34 slides the cap unit 31 to a home position and a maintenance position. The home position (see FIG. 7A) is a position on the right side of the head unit 11 positioned at the image forming position. The maintenance position (see FIG. 7F) is a position below the head unit 11 positioned at the retracted position.

[Wipe Lifting Device] The wipe lifting device 35 (see FIG. 4) is provided on the front and rear sides of the waste liquid tray 81 of the wipe unit 32. The wipe lifting device 35 includes, for example, a ball screw, a belt driving device, and the like. The wipe lifting device 35 lifts and lowers the wipe unit 32 to a contact position where the waste liquid tray 81 is in contact with the cap 72 (see FIG. 7B) and a separated position where the waste liquid tray 81 is separated from the cap 72 by a predetermined distance (see FIG. 7E).

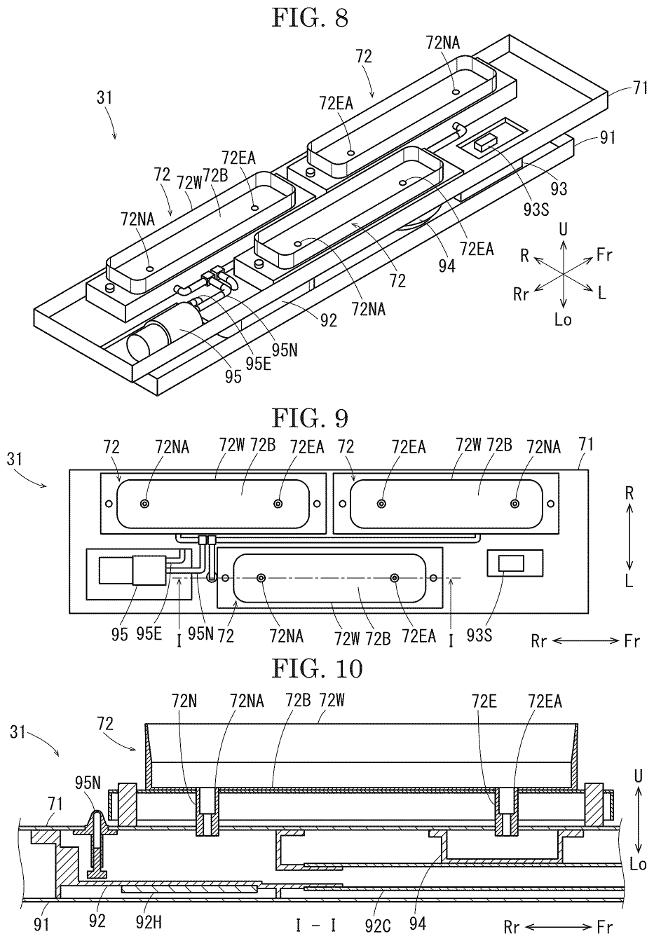

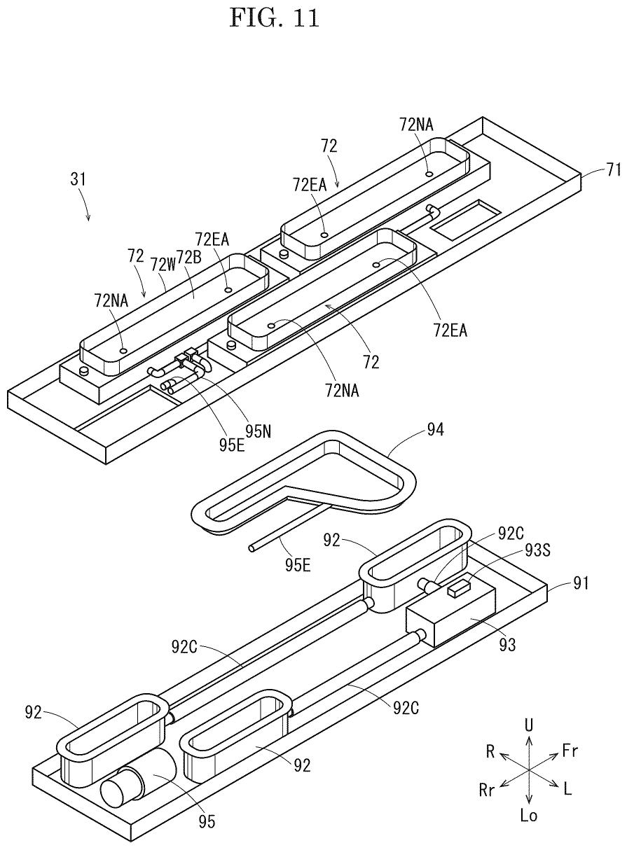

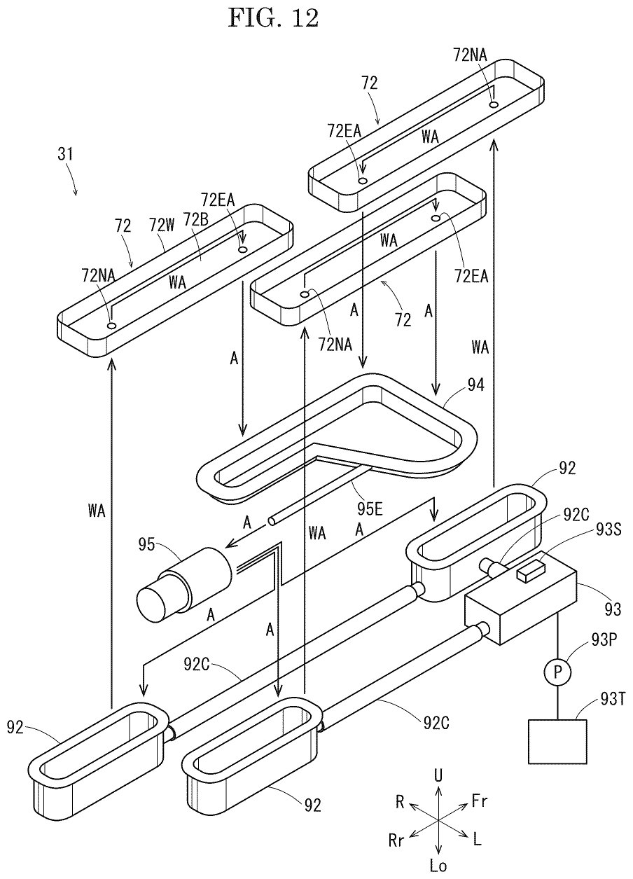

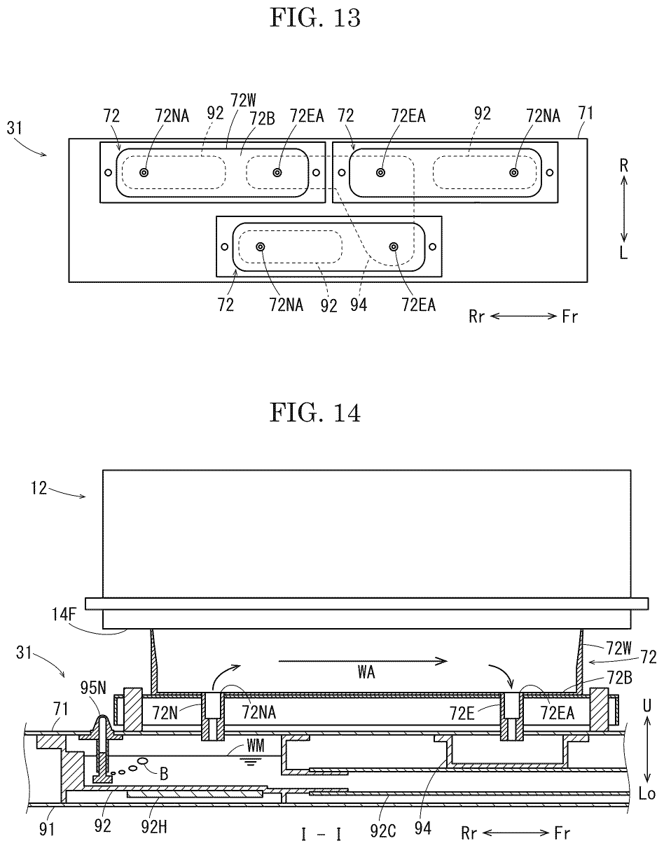

Next, the structure of the cap unit 31 will be described in detail. FIG. 8 is a perspective view showing the cap unit 31. FIG. 9 is a plan view showing the cap unit 31. FIG. 10 is a cross-sectional view taken along the line I-I of FIG. 9. FIG. 11 is a disassembled view showing the cap unit 31. FIG. 12 is a view explaining a flow of air A and humidified air WA in the cap unit 31. FIG. 13 is a plan view showing positions of a humidification tank 92 and a recovery tank 94. FIG. 14 is a cross-sectional view showing a flow of the humidified air WA in the cap 72.

[Cap] The cap 72 (see FIG. 8 to FIG. 10) is formed in a box shape opened upward. The cap 72 includes a generally rectangular bottom portion 72B whose longitudinal direction is along the front-and-rear direction, and a side wall portion 72W standing upright from the edge of the bottom portion 72B. The side wall portion 72W is made of flexible material such as rubber. The bottom portion 72B is provided with an air supply port 72NA and an air discharge port 72EA. In the right rear cap 72 and left caps 72, the air supply port 72NA is provided on the rear side portion and the air discharge port 72EA is provided on the front side portion. In the right front cap 72, the air supply port 72NA is provided on the front side portion, and the air discharge port 72EA is provided on the rear side portion.

[Humidification Tank, Recovery Tank] Humidification tanks 92 of the same number as the caps 72 (in this embodiment, three) and one recovery tank 94 are provided below the frame 71 (see FIG. 8, FIG. 11 to FIG. 13). The humidification tanks 92 and the recovery tank 94 are supported by a frame body 91. Each humidification tank 92 is disposed below the air supply port 72NA of each cap 72. The recovery tank 94 has a shape including all the air discharge ports 72EA in a plan view, and is arranged below all the air discharge ports 72EA.

An air supply pipe 72N (see FIG. 10) for communicating the cap 72 with the humidification tank 92 disposed below is connected to the air supply port 72NA of each cap 72. An air discharge pipe 72E for communicating the cap 72 with the recovery tank 94 is connected to the air discharge port 72EA of each cap 72. That is, three air discharge pipes 72E are communicated with the recovery tank 94.

An air pump 95 is connected to the recovery tank 94 by a recovery flow pass 95E (see FIG. 8, FIG. 9 and FIG. 11), and is connected to all the humidification tanks 92 by a supply flow pass 95N. The air pump 95 recovers air A from the recovery tank 94 via the recovery flow pass 95E and supplies the recovered air A to all the humidification tanks 92 via the supply flow pass 95N (see FIG. 12).

All the humidification tanks 92 are connected to a humidification sub-tank 93 through communication pipes 92C (see FIG. 10, FIG. 11 and FIG. 12). A humidification medium tank 93T and a humidification medium pump 93P are connected to the humidification sub-tank 93. A humidification medium WM (see FIG. 14) is stored in the humidification medium tank 93T. The humidification medium WM is, for example, water. The humidification medium pump 93P supplies the humidification medium WM from the humidification medium tank 93T to the humidification sub-tank 93. The humidification sub-tank 93 is provided with a liquid surface sensor 93S (see FIG. 8, FIG. 9 and FIG. 11) for detecting a height of the liquid in the humidification sub-tank 93. The humidification tank 92 is provided with a heater 92H (see FIG. 10) for heating the humidification medium WM.

Next, the basic operation of the maintenance device 30 will be described. In the initial state (see FIG. 7A), the head unit 11 is positioned at the image forming position and the cap unit 31 is positioned at the home position. The wipe unit 32 is mounted on the cap unit 31. That is, the waste liquid tray 81 is in contact with the caps 72. The control part 2 executes the following processing at a predetermined timing. The predetermined timing is, for example, the timing at which it is predicted that the viscosity of the ink in the nozzle 14N is increased, and more specifically, when a period during which the image forming job is not performed continues for a predetermined period.

First, the control part 2 actuates the head lifting device 11L to lift the head unit 11 to the retracted position (see FIG. 7B). Next, the control part 2 actuates the cap sliding device 34 to slide the cap unit 31 to the maintenance position (see FIG. 7C). At this time, since the wipe unit 32 is mounted on the cap unit 31, the wipe unit 32 slides to the maintenance position together with the cap unit 31. Next, the control part 2 actuates the head lifting device 11L to lower the head unit 11 to a height at which the nozzle surface 14F is in contact with the cleaning member 82 (see FIG. 7D).

Next, the control part 2 forcibly ejects a predetermined amount of the ink from the inkjet head 12, supplies the cleaning liquid to the nozzle surface 14F, and then slides the cleaning member 82 along the nozzle surface 14F. Then, the ink remaining on the nozzle surface 14F is diluted with the cleaning liquid, and the waste liquid containing the ink and the cleaning liquid is wiped off by the cleaning member 82 and falls into the waste liquid tray 81.

Next, the control part 2 actuates the head lifting device 11L to lift the head unit 11 to the retracted position (see FIG. 7C). Next, the control part 2 actuates the cap sliding device 34 to slide the cap unit 31 and the wipe unit 32 to the home position (see FIG. 7B).

Next, the control part 2 actuates the wipe lifting device 35 to lift the wipe unit 32 to the separated position (see FIG. 7E). Next, the control part 2 actuates the cap sliding device 34 to slide the cap unit 31 to the maintenance position (see FIG. 7F). At this time, since the wipe unit 32 is separated from the cap unit 31, the wipe unit 32 remains at the home position, and only the cap unit 31 is slide to the maintenance position.

Next, the control part 2 actuates the head lifting device 11L to lower the head unit 11 to a height at which the nozzle surface 14F is in contact with the cap 72 (see FIG. 7G). Thus, the cap 72 is covered on the nozzle surface 14F.

Next, the control part 2 humidifies the inside of the cap 72. The control part 2 monitors a measured value by the liquid surface sensor 93S, and maintains a height of the liquid surface in the humidification sub-tank 93 within a predetermined range. Specifically, when a measured value of the liquid surface is lowered below the predetermined range, the humidification medium pump 93P is used to replenish a predetermined amount of the humidification medium WM from the humidification medium tank 93T to the humidification sub-tank 93. Since the humidification sub-tank 93 is communicated with the humidification tank 92 by the communication pipe 92C, a height of the liquid surface of the humidification medium WM is in uniform the humidification sub-tank 93 and all the humidification tanks 92.

The air pump 95 (see FIG. 12) recovers the air A from the recovery tank 94 via the recovery flow pass 95E, and supplies the recovered air A to all the humidification tanks 92 via the supply flow pass 95N. An end portion of the supply flow pass 95N on the side of the humidification tank 92 is disposed below the liquid surface of the humidification medium WM (see FIG. 14). Therefore, the air A is blown into the humidification medium WM in the humidification tank 92, and bubbles B are generated. A water vapor pressure of the bubble B increases until the bubble B rises to the liquid surface. Since the humidification medium WM in the humidification tank 92 is heated by the heater 92H, the water vapor is easily generated. Therefore, the space above the liquid surface of the humidification tank 92 is filled with the humidified air WA having an increased water vapor pressure, and the humidified air WA flows into the cap 72 through the air supply pipe 72N.

On the other hand, in the recovery tank 94, since the air A is sucked by the air pump 95, a negative pressure is generated. Therefore, a flow of the humidified air WA from the air supply port 72NA to the air discharge port 72EA is generated in the cap 72. Since the humidified air WA heated by the heater 92H is supplied to the cap 72, a convection is generated in the cap 72, and the high temperature humidified air WA is supplied to the nozzle surface 14F. Thus, the humidified air WA is exposed to the ink in the nozzle 14N, and the viscosity increase of the ink is suppressed.

When the image forming job is performed, the control part 2 actuates the head lifting device 11L to lift the head unit 11 to the retracted position (see FIG. 7F), actuates the cap sliding device 34 to slide the cap unit 31 to the home position (see FIG. 7E), and actuates the wipe lifting device 35 to lower the wipe unit 32 to the contact position (see FIG. 7B). Then, the control part 2 actuates the head lifting device 11L to lower the head unit 11 to the image forming position, and then performs the image forming job.

By the way, since the humidified air WA flowing into the cap 72 through the air supply pipe 72N rises toward the nozzle surface 14F, the humidified air WA is directly exposed to the nozzle surface 14F, and in such a case, there is a possibility that a condensation is generated on the nozzle surface 14F, and the ink is pulled by the condensation and leaves the nozzle 14N. The fallen ink may be deposited in the cap 72 and obstruct the flow of the humidified air WA or clog the air supply pipe 72N.

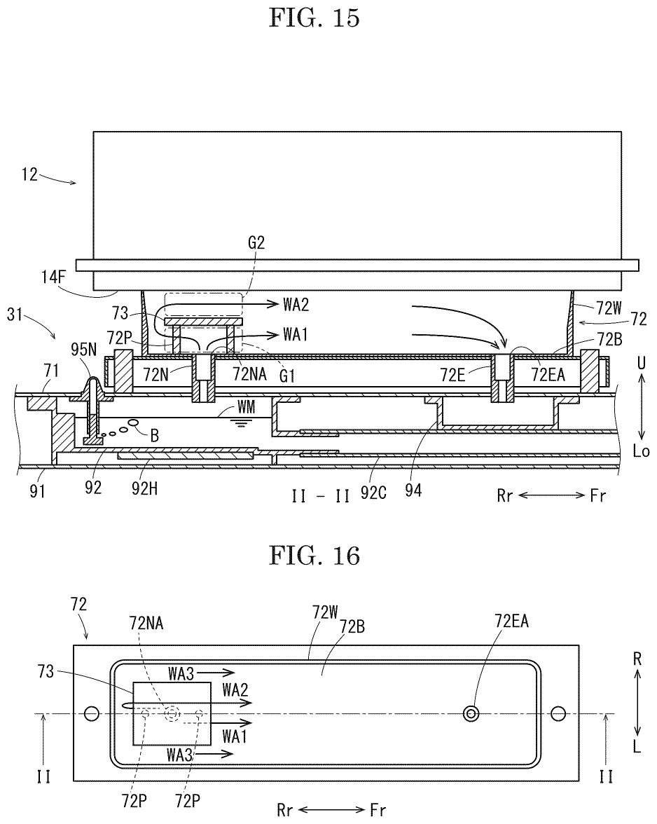

Therefore, the maintenance device 30 according to the present embodiment includes a suppression member 73. FIG. 15 is a cross-sectional view showing the cap unit 31 provided with the suppression member 73. FIG. 16 is a plan view showing the cap 72 provided with the suppression member 73. FIG. 15 is a cross-sectional view taken along the line II-II in FIG. 16.

The maintenance device 30 according to the present embodiment includes the cap 72 covering the nozzle surface 14F of the inkjet head 12, the air supply port 72NA provided on the cap 72, and the suppression member 73 provided at least between the air supply port 72NA and the nozzle surface 14F, having a first gap G1 from the air supply port 72NA and a second gap G2 from the nozzle surface 14F. Specifically, they are as follows.

The suppression member 73 is provided above the air supply port 72NA. The suppression member 73 is a plate-like member whose thickness direction is along the upper-and-lower direction, and is made of resin. The suppression member 73 is supported by posts 73P provided on the bottom portion 72B of the cap 72. The dimension of the suppression member 73 in the front-and-rear direction and the left-and-right direction is larger than that of the air supply port 72NA. The suppression member 73 is provided so as to cover at least the entire air supply port 72NA in a plan view. The first gap G1 is provided between the air supply port 72NA and the lower surface of the suppression member 73. The second gap G2 is provided between the nozzle surface 14F and the upper surface of the suppression member 73.

A part WA1 (see FIG. 15) of the humidified air flowing into the cap 72 from the air supply port 72NA flows forward from the first gap G1, and is sucked into the air discharge port 72EA. Another part WA2 of the humidified air flows from the first gap G1 to the second gap G2 via the rear side of the suppression member 73, flows forward from the second gap G2, and is sucked into the air discharge port 72EA. Another part of the humidified air WA3 (see FIG. 16) flows forward from the left and right spaces of the suppression member 73, and is sucked into the air discharge port 72EA. That is, since the humidified air WA flows along the lower and upper surfaces of the suppression member 73 above the air supply port 72NA, the humidified air WA is not directly exposed to the nozzle surface 14F above the air supply port 72NA. As a result, the generation of condensation on the nozzle surface 14F is suppressed, and the ink is prevented from being pulled by the condensation and leaving the nozzle 14N.

The reason why the suppression member 73 is made of resin is as follows. The condensation may occur in the suppression member 73 when the suppression member 73 takes heat away from the humidified air WA. In particular, in the present embodiment, since the heater 92H is provided in the humidification tank 92 in order to increase an amount of water vapor in the humidified air WA, the condensation tends to occur. When the condensation occurs, the water vapor pressure of the humidified air WA decreases, thereby reducing the humidifying effect on the ink in the nozzle 14N. To suppress the condensation, it is desirable to made the suppression member 73 of material having a low thermal conductivity. In general, since resin has a lower thermal conductivity than metal, it is suitable as the material for the suppression member 73.

The maintenance device 30 according to the present embodiment described above includes the cap 72 covering the nozzle surface 14F of the inkjet head 12, the air supply port 72NA provided on the cap 72, and a suppression member 73 provided at least between the air supply port 72NA and the nozzle surface 14F, having the first gap G1 from the air supply port 72NA and the second gap G2 from the nozzle surface 14F. According to this embodiment, it is possible to prevent the humidified air WA from directly exposed to the nozzle surface 14F.

According to the maintenance device 30 according to the present embodiment, the suppression member 73 is made of resin. According to this embodiment, the condensation of the humidified air WA can be suppressed.

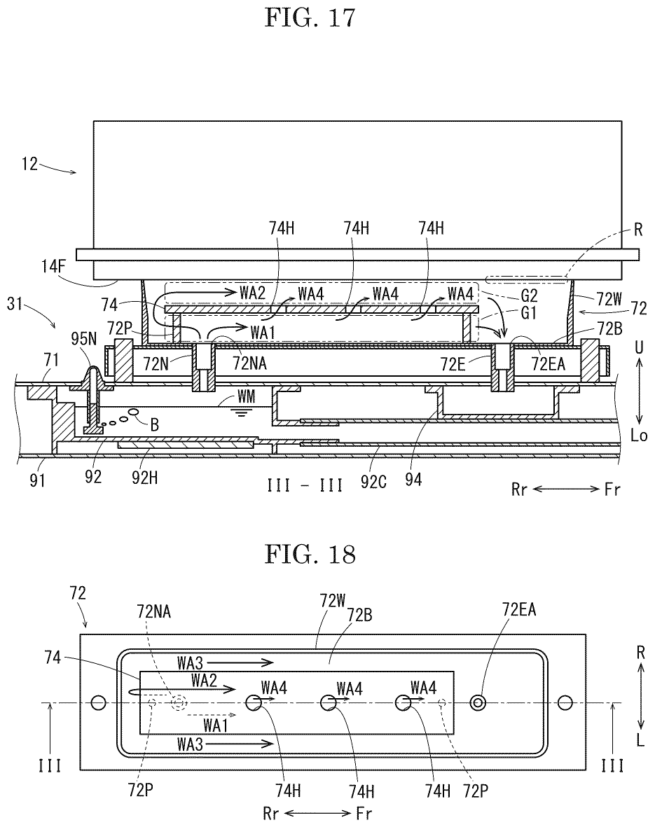

The inkjet recording apparatus according to the present embodiment includes the inkjet head 12 and the maintenance device 30. According to the present embodiment, the increase in the viscosity of the ink in the nozzle 14N of the inkjet head 12 can be suppressed.

[Second Embodiment] FIG. 17 is a cross-sectional view showing the cap unit 31 provided with the suppression member 74 according to the second embodiment. FIG. 18 is a plan view showing the cap 72 provided with the suppression member 74 according to the second embodiment.

The suppression member 74 is provided along a direction from the air supply port 72NA to the air discharge port 72EA. Specifically, the suppression member 74 is a rectangular plate-like member whose longitudinal direction is along the direction from the air supply port 72NA to the air discharge port 72EA. The suppression member 74 is supported by posts 74P provided on the bottom portion 72B of the cap 72. The rear end portion of the suppression member 74 is disposed above the air supply port 72NA. The front end portion of the suppression member 74 is located on the rear side of the air discharge port 72EA. The first gap G1 is provided between the air supply port 72NA and the lower surface of the suppression member 74. The second gap G2 is provided between the nozzle surface 14F and the upper surface of the suppression member 74.

The suppression member 74 is provided with a through-hole 74H penetrating from the side of the air supply port 72NA to the side of the nozzle surface 14F at a position not facing the air supply port 72NA. The through-hole 74H is provided at a plurality of positions (in this embodiment, three) along the direction from the air supply port 72NA to the air discharge port 72EA.

A part WA1 (see FIG. 15) of the humidified air flowing into the cap 72 from the air supply port 72NA flows forward through the first gap G1, and is sucked into the air discharge port 72EA. Another part of the humidified air WA2 flows from the first gap G1 to the second gap G2 via the rear side of the suppression member 74, flows forward through the second gap G2, and is sucked into the air discharge port 72EA. Another part of the humidified air WA3 (see FIG. 16) flows forward through the left and right spaces of the suppression member 73, and is sucked into the air discharge port 72EA. That is, since the humidified air WA flows along the lower and upper surfaces of the suppression member 74 over a wider area than in the above embodiment, it is possible to prevent the humidified air WA from directly exposed to the nozzle surface 14F over a wider area than in the above embodiment.

A part WA4 of the humidified air flowing through the first gap G1 to the air discharge port 72EA flows through the through-holes 74H from the first gap G1 to the second gap G2, so that the insufficient supply of the humidified air WA by the suppression member 74 can be compensated. Further, the humidified air WA is also supplied to the nozzle surface 14F separated from the air supply port 72NA through the through-holes 74H, so that the uniformity of the humidification to the nozzle surface 14F is improved.

According to the maintenance device 30 according to the embodiment described above, the cap 72 includes the air discharge 72EA, and the suppression member 74 is provided along the direction from the air supply port 72NA to the air discharge port 72EA. According to this embodiment, it is possible to prevent the humidified air WA from directly exposed to the nozzle surface 14F over a wide area along the direction from the air supply port 72NA to the air discharge port 72EA.

According to the maintenance device 30 according to the present embodiment, the suppression member 74 has the through-holes 74H penetrating from the side of the air supply port 72NA to the side of the nozzle surface 14F at a position not facing the air supply port 72NA. According to this embodiment, an insufficient supply of the humidified air WA by the suppression member 74 can be compensated.

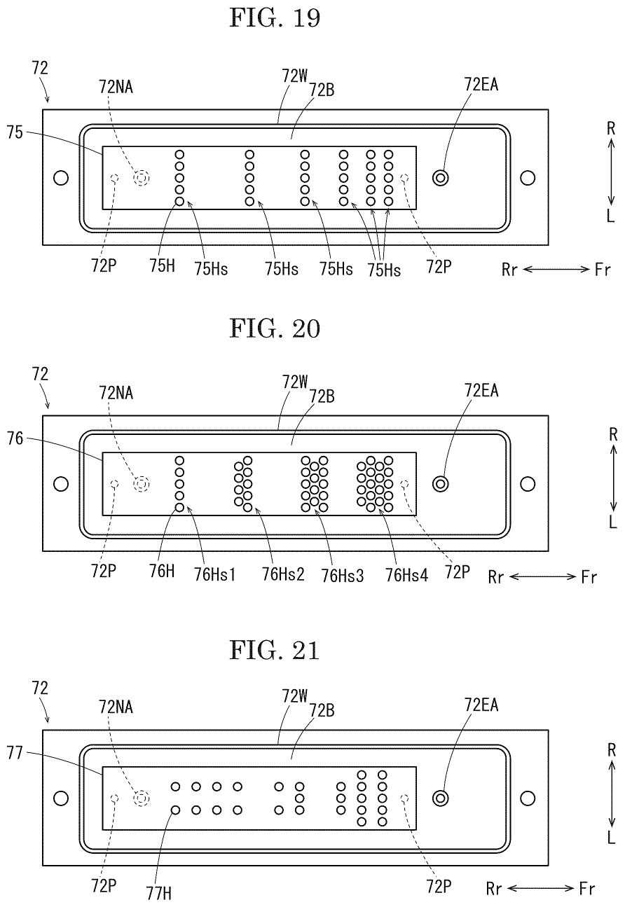

According to the maintenance device 30 according to the present embodiment, the cap 72 includes the air discharge port 72EA, and the through-hole 74H is provided at a plurality of positions along the direction from the side of the air supply port 72NA to the side of the air discharge port 72EA. According to this embodiment, the uniformity of the humidification to the nozzle surface 14F can be improved.

[Third Embodiment] FIG. 19 is a plan view showing the cap 72 provided with the suppression member 75 according to a third embodiment. The maintenance device 30 according to the present embodiment includes the cap 72 covering the nozzle surface 14F of the inkjet head 12, the air supply port 72NA and the air discharge port 72EA provided on the cap 72, and the suppression member 75 provided at least between the air supply port 72NA and the nozzle surface 14F, having the first gap G1 from the air supply port 72NA and the second gap G2 from the nozzle surface 14F. The suppression member 75 has a plurality of the through-holes 75H penetrating from the side of the air supply port 72NA to the side of the nozzle surface 14F at a position not facing the air supply port 72NA, the through-holes 75H have the same diameter, and the density of the through-holes 75H is higher as they are closer to the air discharge port 72EA.

Specifically, a through-hole groups 75Hs including the through-holes 75H is provided at a plurality of positions along the direction from the air supply port 72NA to the air discharge port 72EA, and the closer to the air discharge port 72EA, the shorter the distance between the adjacent through-hole groups 75Hs. In the illustrated example, a number of the through-holes 75H included in the through-hole group 75Hs is five, but the number of the through-holes 75H included in the through-hole group 75Hs may be any number.

According to this embodiment, compared with the case where the density of the through-holes 75H is uniform, the uniformity of the humidification to the nozzle surface 14F can be improved. According to the present embodiment, compared with the case where the through-hole groups 75Hs are provided at equal intervals in the direction from the air supply port 72NA to the air discharge 72EA, uniformity port the of humidification to the nozzle surface 14F can be improved.

[Fourth Embodiment] FIG. 20 is a plan view showing the cap 72 provided with the suppression member 76 according to a fourth embodiment. In the maintenance device 30 according to the present embodiment, the through-hole groups 76Hs1 to 76Hs4 including the through-holes 76H are provided at a plurality of positions along the direction from the air supply port 72NA to the air discharge port 72EA, and a number of the through-holes 76H included in each of through-hole group 76Hs1 to 76Hs4 increases as it is closer to the air discharge port 72EA.

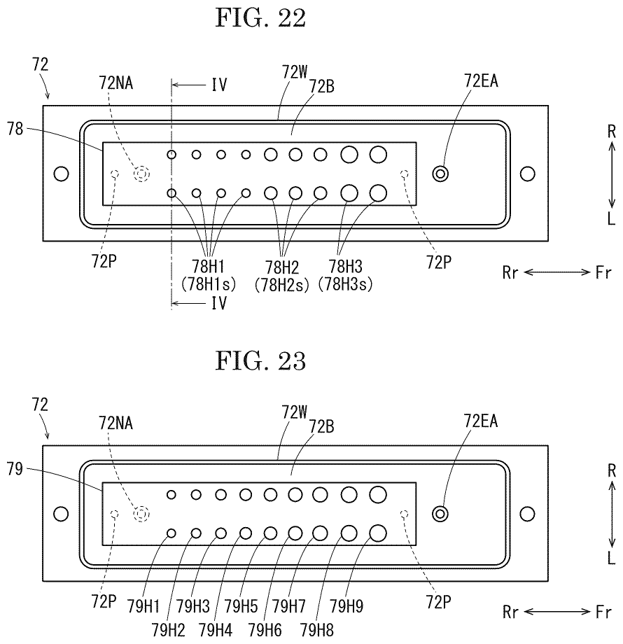

In the illustrated example, the through-hole groups 76Hs1 to 76Hs4 include the five, nine, fourteen and eighteen through-holes 76H, respectively. In the illustrated example, when a number of the through-hole 76H included in each of the through-holes groups 76Hs1 to 76Hs4 exceeds five, the through-holes 76H are arranged in a staggered pattern, but the through-holes 76H may be arranged in any manner in the through-hole groups 76Hs1 to 76Hs4. In the illustrated example, the closer they are to the air discharge port 72EA, the shorter the distance between the adjacent through-hole groups 75Hs1 to 75Hs4 becomes, but the distance between the adjacent through-hole groups 76Hs1 to 76Hs4 may be constant. According to this embodiment, compared with the case where a number of the through-holes 76H included in the through-hole groups 76Hs1 to 76Hs4 is the same, the uniformity of humidification to the nozzle surface 14F can be improved.

[Fifth Embodiment] FIG. 21 is a plan view showing the cap 72 provided with the suppression member 77 according to a fifth embodiment. Although the arrangement of the through-holes 77H is different from that of the third and fourth embodiments, in the present embodiment, the through-holes 77H have the same diameter, and the closer they are to the air discharge port 72EA, the higher the density of the through-holes 77H is. In this embodiment, as compared with the case where the density of the through-holes 77H is uniform, the uniformity of the humidification to the nozzle surface 14F can be improved.

[Sixth Embodiment] FIG. 22 is a plan view showing the cap 72 provided with the suppression member 78 according to a sixth embodiment. The maintenance device 30 according to the present embodiment includes the cap 72 covering the nozzle surface 14F of the inkjet head 12, the air supply port 72NA and the air discharge port 72EA provided on the cap 72, and the suppression member 78 provided at least between the air supply port 72NA and the nozzle surface 14F, having the first gap G1 from the air supply port 72NA and the second gap G2 from the nozzle surface 14F. The suppression member 78 has a plurality of the through-holes 78H1 to 78H3 penetrating from the side of the air supply port 72NA to the side of the nozzle surface 14F at a position not facing the air supply port 72NA, and the closer they are to the air discharge port 72EA, the larger the diameter of the through-holes 78H1 to 78H3 is.

Specifically, the through-hole groups 78H1s, 78H2s, and 78H3s including the through-holes 78H1, 78H2, and 78H3 are provided at a plurality of positions along the direction from the air supply port 72NA to the air discharge port 72EA, and the closer they are to the air discharge port 72EA, the larger the diameter of through-holes 78H1, 78H2, and 78H3 included in the through-hole groups 78H1s, 78H2s, and 78H3s are. According to this embodiment, compared with the case where the diameter of the through-holes 78H1, 78H2, and 78H3 included in the through-hole groups 78H1s, 78H2s, and 78H3s are the same, the uniformity of humidification to the nozzle surface 14F can be improved.

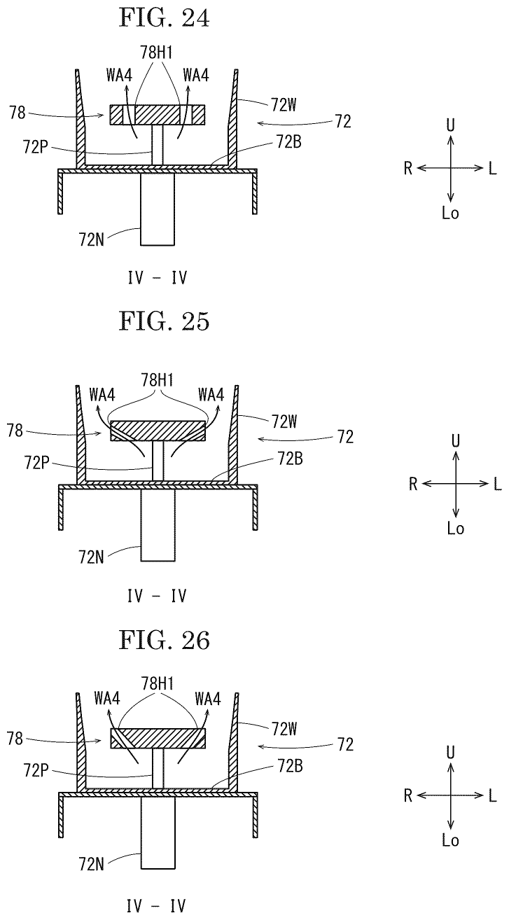

FIG. 24 is a cross-sectional view taken along the line IV-IV of FIG. 22. The suppression member 78 is provided along the direction from the air supply port 72NA to the air discharge port 72EA, and the through-holes 78H1 to 78H3 are provided in both end side portions of the suppression member 78 in a width direction intersecting the direction from the air supply port 72NA to the air discharge port 72EA. The through-holes 78H1 to 78H3 penetrate from the bottom surface to the top surface of the suppression member 78. According to this embodiment, compared with the case where the through-holes 78H1 to 78H3 are provided in the center portion in the width direction, the uniformity of the humidification in the width direction with respect to the nozzle surface 14F can be improved.

FIG. 25 is a cross-sectional view showing a first modified example of the sixth embodiment. The through-holes 78H1 to 78H3 penetrate from the bottom surface to the lateral surface of the suppression member 78. According to the present embodiment, the uniformity of the humidification in the width direction with respect to the nozzle surface 14F can also be improved.

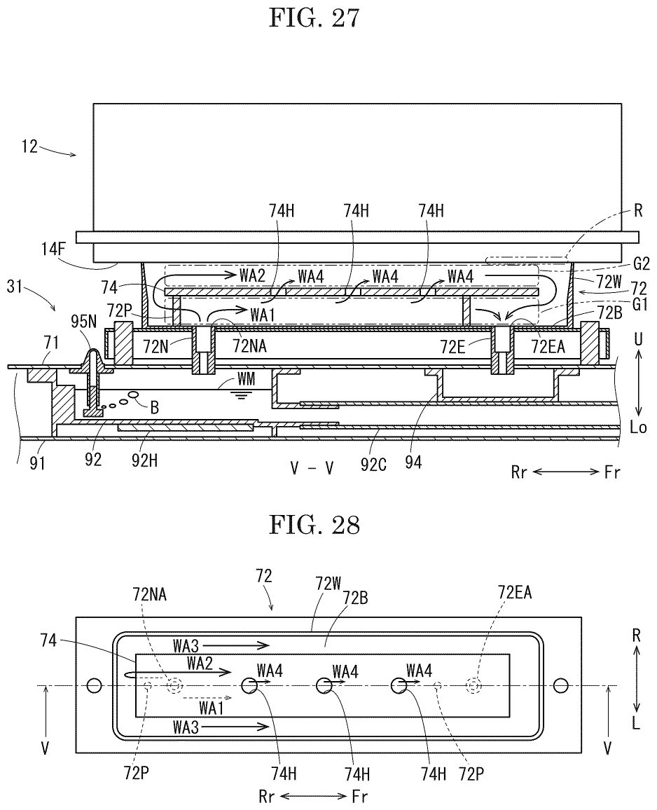

FIG. 26 is a cross-sectional view showing a second modified example of the sixth embodiment. The through-holes 78H1 to 78H3 penetrate from the bottom surface of the suppression member 78 to the edge portion where the top surface and the lateral surface intersect. According to the present embodiment, the uniformity of the humidification in the width direction with respect to the nozzle surface 14F can also be improved.

[Seventh Embodiment] FIG. 23 is a plan view showing the cap 72 provided with the suppression member 79 according to a seventh embodiment. In this embodiment, the diameters of the through-holes 79H1 to 79H9 are gradually increased as the closer they are to the air discharge port 72EA. According to the present embodiment, the uniformity of the humidification to the nozzle surface 14F can also be improved.

[Eighth Embodiment] FIG. 27 is a cross-sectional view showing the cap unit 31 provided with the suppression member 74 according to an eighth embodiment. FIG. 28 is a plan view showing the cap 72 provided with the suppression member 74 according to the eighth embodiment. In the second embodiment (see FIG. 17), since the end portion of the suppression member 74 on the side of the air discharge port 72EA is located on the rear side of the air discharge port 72EA, there is a problem that the humidified air WA is hardly supplied to a region R in front of the end portion of the suppression member 74 on the side of the air discharge port 72EA in the nozzle surface 14F.

Therefore, in the present embodiment, the end portion of the suppression member 74 on the side of the air discharge port 72EA faces the air discharge port 72EA. According to this embodiment, since the humidified air WA flowing forward through the second gap G2 enters the first gap G1 from the front side of the suppression member 74 and is sucked into the air discharge port 72EA, the humidified air WA can also be supplied to the nozzle surface 14F on the side of the air discharge port 72EA. Therefore, according to the present embodiment, the uniformity of the humidification to the nozzle surface 14F can be improved.

The invention claimed is:

1. A maintenance device comprising:
a cap covering a nozzle surface of an inkjet head;
an air supply port and an air discharge port provided in the cap; and
a suppression member provided between the nozzle surface and the air supply port, having a first gap from the air supply port and a second gap from the nozzle surface, wherein
the suppression member has a plurality of through-holes penetrating from a side of the air supply port to a side of the air discharge port at a position not facing the air supply port,
the through-holes have the same diameter, and
the closer the through-holes are to the air discharge port, the higher a density of the through-holes is.

2. The maintenance device according to claim 1, wherein
a through-hole group including the through-holes is provided at a plurality of positions along a direction from the air supply port to the air discharge port, and
the closer the groups are to the air discharge port, the shorter a distance between the adjacent through-holes groups is.

3. The maintenance device according to claim 1, wherein
a through-hole group including the through-holes is provided at a plurality of positions along a direction from the air supply port to the air discharge port, and
the closer the groups are to the air discharge port, the larger a number of the through-holes included in the through-holes group is.

4. The maintenance device according to claim 1, wherein
the suppression member is made of resin.

5. An inkjet recording apparatus comprising:
the inkjet head; and
the maintenance device according to claim 1.
